(19) United States
(12) Patent Application Publication
(10) Pub. No.: US 2005/0129870 A1
(43) Pub. Date: Jun. 16, 2005

(54) Procedure and arrangement for coating a metal surface with a thin layer containing metal

(75) Inventor: Raimo Vartiainen, Hyvinkaa (FI)

Correspondence Address: BIRCH STEWART KOLASCH & BIRCH, PO BOX 747, FALLS CHURCH, VA, 22040-0747, US

(73) Assignee: Bondmet OY, Nummela (FI)

(21) Appl. No.: 10/502,194

(22) PCT Filed: Jan. 21, 2003
(86) PCT No.: PCT/FI03/00049

(30) Foreign Application Priority Data
Jan. 24, 2002 (FI) 20020130

(51) Int. Cl. B05D 1/18; B05D 3/12; B05D 1/12

(52) U.S. Cl. 427/458; 427/355; 427/434.2; 427/180

(57) ABSTRACT

The invention relates to a method for coating a metal surface, such as the surface of liquid flow tubes (3) used in cooling radiators and heat exchangers, with a thin layer of material containing metal. In the method, the material (6) intended for coating is caused to adhere to the tube in a container-like space (5), whereupon the liquid flow tube (3) is passed out of the container-like space (5) and the material layer (15) intended to form a coating is adjusted to a predesired position and thickness. According to the method, the elongated side faces (14) of the liquid flow tube (3) are caused to collapse towards each other, whereupon the liquid flow tube (3) is passed into the container-like space (5), where coating material (6) is adhered to the surface of the tube (3). After the adherence, the original profile of the tube (3) is restored by causing the elongated side faces (14) of the tube (3) to buckle outwards from each other.

The present invention relates to a method as defined in the preamble of claim 1 and to an apparatus as defined in the preamble of claim 7 for coating a metal surface with a thin layer containing metal.

The solution of the invention is applicable for coating several surface materials with a thin layer containing metal. The solution of the invention is well suited for coating metal surfaces and very well suited for coating e.g. the tubing carrying a liquid flow in the manufacture of heat exchangers and e.g. radiators for liquid-cooled vehicles with soldering material to allow the folded copper fins having a good heat delivery capacity to be soldered between the tubes carrying a liquid flow.

The pastelike soldering material consists mainly of copper, the proportion of which is generally 75%, and nickel, tin and phosphor. The mixture is atomized to give it a fine-grained composition, with a grain size of 1 . . . 90 μm. The characteristic weight of the mixture is about 5.5 kg/dm³. To obtain a smooth coating and to make it easy to apply the material to a desired place, the aforesaid dry powder mixture is further mixed in a suitable liquid medium. In addition, a binding agent, such as a thermoplastic or reticulatng polymer, is added to the mixture. Examples of such binding agents are acrylic polymer, wax or hot wax. To prevent sedimentation of the heavy powder, a suitable auxiliary substance is added to the mixture during the dispersing stage. Moreover, it is important that, after the heating stage with the temperature reaching up to 620° C., the final mixture should not contain any substances that would leave soldering residue, e.g. carbon or the like, on the soldered joint. If any residue remains, it has to be removed manually.

In a prior-art method, a paste-like soldering material is sprayed onto the surface of flat liquid tubes from at least two different directions. In this method, tubes cut beforehand to appropriate lengths are placed side by side in a mount constructed for this purpose. After the spraying, the tubes are treated in a hot air tunnel to evaporate any liquid and to fasten the film to the surface of the tubes. A drawback with the above-described solution is that, during the spraying, as much as 20% of the soldering material is wasted so that it cannot be recovered. Material is wasted e.g. by being sprayed past the tubes, by being unnecessarily sprayed onto parts of tube surfaces where no soldering material is needed and because of difficulties of controlling the thickness of the soldering material layer. A further drawback is that it is difficult to maintain a homogeneous state of the soldering material in the spraying vessels because the solder mixture is so heavy, consisting of metal particles, among other things. Another drawback is that the spraying apparatus may be clogged, which may lead to considerable variations in the thickness of the coating consisting of soldering material. A further drawback is that the prior-art solution is relatively slow, requires many work stages and at least two operators and additionally a readjustment for each different tube length. Yet another drawback is the solvent emissions occurring as soldering material is sprayed past the tubes. The apparatus according to the prior-art solution is also of a large size and expensive to purchase. Finally, a drawback is also the fact that the prior-art solution cannot be used with all existing soldering material compositions and solidifying techniques.

In general, besides the method described above, there are also other methods for applying a soldering material. These include rolling application, silk screen printing application and injection or extrusion application. However, these methods are still less suited for the coating of tubes as described above with a soldering material than the aforesaid spraying application.

The object of the present invention is to overcome the drawbacks of prior art and to achieve a compact, economical, reliable, operative method and apparatus as free of emissions as possible for coating a metal surface with a thin layer containing metal. Hereinafter, the method and apparatus will be simply called the solution of the invention. The method of the invention is characterized by what is presented in the characterization part of claim 1, and the apparatus of the invention is characterized by what is presented in the characterization part of claim 7. Other embodiments of the invention are characterized by what is presented in the other claims.

The solution of the invention has the advantage that the coating material to be applied can be accurately focused to the desired surface area, which means that e.g. when soldering material is used for the coating of tubes, a saving of about 20% in soldering material is achieved as compared with the spraying application described above. A further advantage is that, by blowing off any non-desirable soldering material paste from the short end faces of the tubes, the end faces can easily be made clean while saving a further 12% of soldering material, An additional advantage in the manufacture and coating of tubes is that the tube can be pushed from a tube production unit at a very high speed through the coating apparatus. Therefore, a very high coating capacity, even more than twice as high as in the aforesaid spraying application method, can be achieved. Moreover, a good and homogeneous quality is maintained even at high speeds because the film thickness of the coating remains constant. There is also the advantage that the film thickness of the coating can be easily adjusted if necessary by means of mechanical adjustable limiters. As compared with the aforesaid spraying method, the solution of the invention is very advantageous in the manufacture of tubes carrying a liquid flow. The total amount of soldering material saved may even exceed 40% and further savings are achieved through the more than double coating speed and the fact that the solution of the invention does not necessarily require more than one operator. A further advantage is that the coating material container can be kept closed, thus preventing any pollutants from escaping into the air during the coating operation. An additional advantage is that the continuous coated tube can be passed into a solidification tube of a relatively small diameter to solidify the coating material. This saves both energy and space. Yet another advantage is that the solution of the invention is suited for use in many applications. It allows the use of any available pastelike, liquid or powdery soldering and coating materials, and it can be used to coat metal surfaces of different sizes and shapes for different purposes.

In the following, the invention will be described in detail by the aid of an embodiment example with reference to the attached drawings, wherein

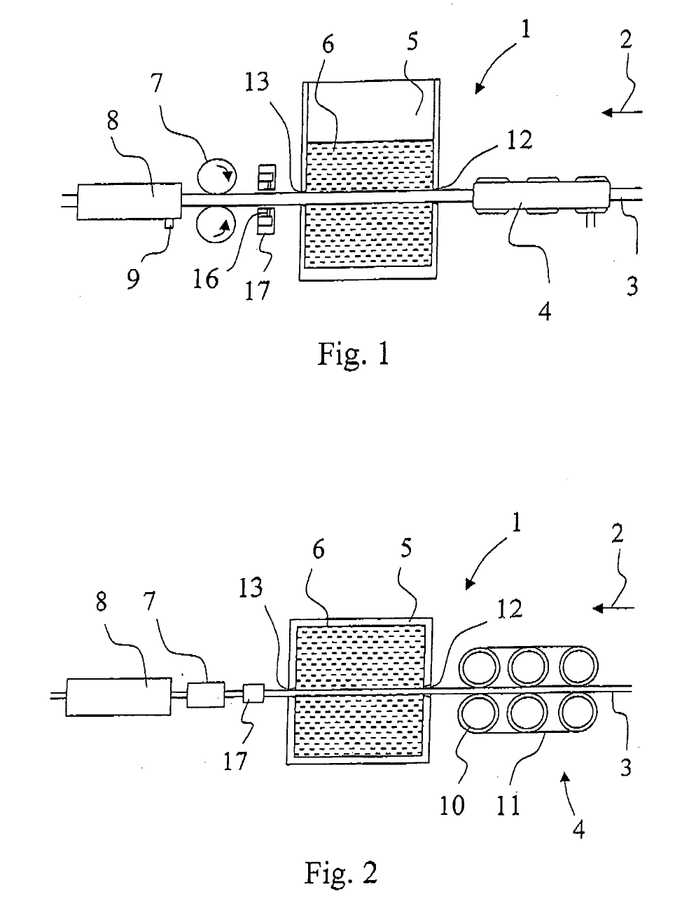

FIG. 1 presents the apparatus of the invention in a simplified and diagrammatic side view,

FIG. 2 presents the apparatus of the invention in a simplified and diagrammatic top view,

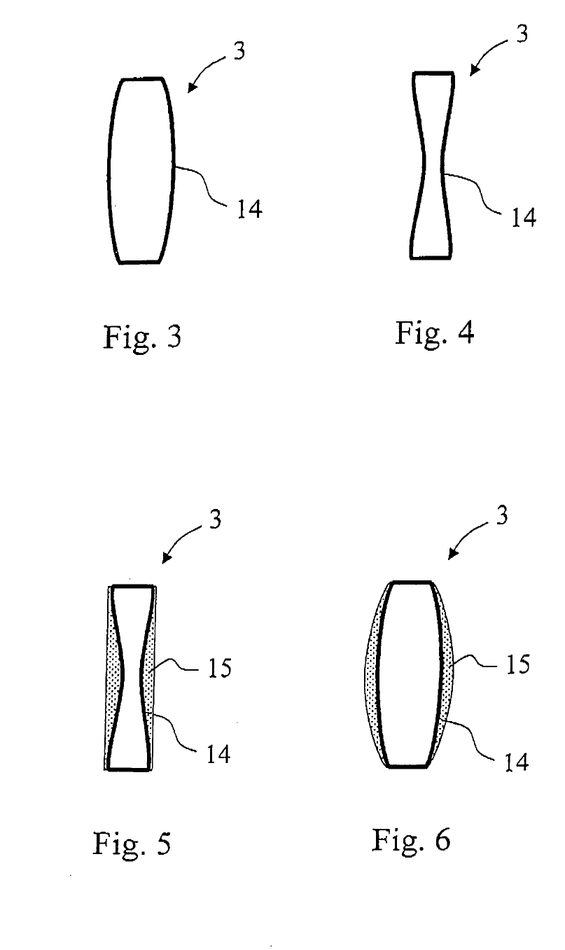

FIG. 3 presents a cross-sectional profile of a liquid flwo tube to be coated, in a situation before the tube is driven into the apparatus of the invention,

FIG. 4 presents a cross-sectional profile of a liquid flow tube to be coated in a situation before the tube is driven into the coating material container of the apparatus of the invention,

FIG. 5 presents a cross-sectional profile of a liquid flow tube coated with soldering material in a situation where the tube is coming out of the coating material container of the apparatus of the invention,

FIG. 6 presents a cross-sectional profile of a liquid flow tube coated with soldering material in a situation after the tube has been restored to its original shape, and

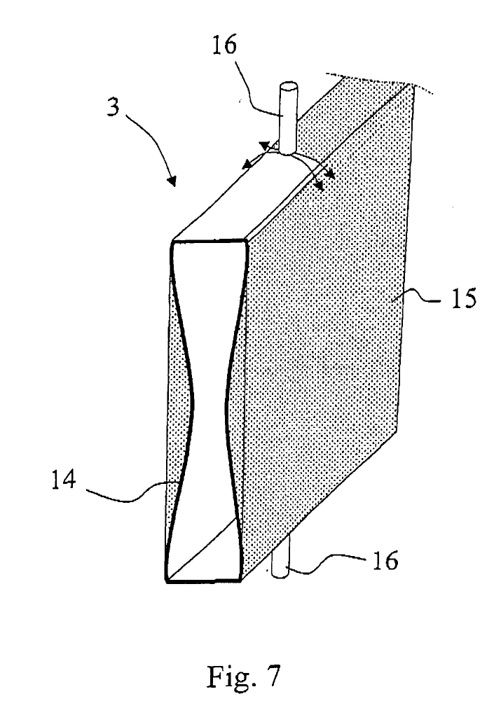

FIG. 7 presents a liquid flow tube coated with soldering material in a simplified perspective view seen obliquely from above.

FIGS. 1 and 2 present a solution according to the invention, applied for the coating of liquid flow tubes with a liquid soldering material paste in connection with the production of the tubes. Comprised in the tube production line is a tube manufacturing machine, which is not shown in the figures. The machine has a reel with e.g. thin bronze band coiled up on it to be used as raw material for the tube. The bronze band is delivered from the reel to the tube manufacturing machine, where a flat bronze tube 3 is formed from the band. The band, drawn by a compressing device 4 functioning as an operating roller system, is passed further out of the tube manufacturing machine. When it leaves the tube manufacturing machine, the tube 3 to be used as a liquid flow tube has a cross-section as shown in FIG. 3, having two opposite long faces 14 connected by shorter end faces. At least the long faces 14 are cambered, i.e. convex, but the end faces may be convex as well.

The compressing device 4 consists of pressing rollers 10 arranged on either side of the liquid flow tube 3 and connected by a belt 11 on each side separately. The pressing rollers 10 may be cylindrical or, as shown in the example, they may have convex lateral surfaces, bulging outwards so that the diameter of the pressing roller 10 is greatest at the middle of the longitudinal axis of the roller and diminishes towards the end of the roller. The function of the compressing device 4 is to both move the tube 3 in the direction of tube movement indicated by the arrow 2 and to press the long faces 14 of the tube so that the camber of the tube in cross-section changes into a form as shown in FIG. 9. The largest diameter of the pressing rollers 10 is substantially at the same height with the middle part of the side face 14 of the tube 3 being driven on in an upright orientation. The pressing rollers are rotated and pressed against the tube 3 by an operating mechanism not shown in the figures.

Placed immediately after the compressing device 4 in the direction of the motion of the tube 3 is a coating material container 5, which may be e.g. a space with an open or closed top and contains e.g. liquid soldering material paste 6. The tube 3 is directed into the coating material container 5 and pushed through the container so that the tube has to pass through the soldering material paste 6 inside. The tube coming out of the coating material container 5 is directed further into a cooling unit 3, which is disposed after the container and which may be a space-saving thin element of tubular form. In the cooling unit, the soldering material paste is solidified e.g. by supplying carbon dioxide through a port 9 into the cooling unit B, with the result that the soldering material is solidified, forming a thin film-like layer on the surface of the tube. After this, the tube 3 is passed into a cutting unit and then further into storage for further treatment.

FIGS. 1 and 2 also show a feed opening 12 in the front wall of the coating material container 5. The feed opening is shaped substantially in the form of the cross-sectional profile of the liquid flow tube 3 and made as tight as possible at least at the interior surface of the container 5 so that no soldering material paste 6 can flow out from the coating material container through the opening. If necessary, sealings may also be used. However, the feed opening is not so tight as to substantially increase friction when the tube is moving through the opening. Both the side edges and the upper and lower edges of the feed opening 12 are splayed in the tube 3 feed direction so that the surface area of the feed opening is larger at the outer surface of the container 5 than at the inner surface of the container 5. This permits easy feed-in of the tube.

In the opposite wall relative to the feed opening 12, the container part of the coating material container 5 has an output opening 13, the function of which is to remove the soldering material layer from areas on the surface of the liquid flow tube 3 where it is undesirable and, if necessary, to adjust the thickness and width of the soldering material layer 15 as appropriate. A suitable output opening profile is a rectangle in which the minimum height of the output opening 13 is substantially equal to the maximum height of the cross-sectional profile of the liquid flow tube 3 to be coated. Correspondingly, the minimum width of the output opening 13 is substantially equal to the maximum width of the liquid tube 3 to be coated, when the tube comes out of the coating material container 5. The maximum height thus corresponds to the final height of the cross-sectional profile of the tube 3, so that, as the tube is coming out through the output opening 13, the output opening simultaneously removes the undesirable soldering material layer from the end faces of the tube 3. Similarly, the maximum width of the output opening 13 corresponds to the width of the cross-section of the tube 3 at the end faces of the tube, because the long faces 14 of the tube have collapsed inwards. While the tube 3 is inside the coating material container 5, it has a cross-section of the form shown in FIG. 4. When the tube 3 comes out through the output opening 13, the soldering material layer 15 adhering to the collapsed side faces 14 of the tube is doctored off where the cross-section is large than the output opening 13, while some of the soldering material remains. Thus, the common cross-sectional profile of the tube 3 and the soldering material layer 15 is substantially the same size and shape with the output opening 13. The output opening 13 is as tight as possible at least at the outer surface of the container 5 to ensure that no soldering material paste 6 can flow out of the coating material container through the opening. If necessary, sealings may also be used. However, the output opening is not so tight as to substantially increase friction as the tube is moving through the opening. To allow easier passage of the tube 3, both the side edges and the upper and lower edges of the output opening 13, too, are splayed in the feed direction of the tube 3 so that the surface area of the feed opening is smaller at the outer surface of the container 5 than at the inner surface of the container 5.

The apparatus is provided with a blowing device 17, which is placed after the coating material container 5 and has at least one nozzle 16. The function of the blowing device 17 is to blow off the soldering material paste before the cooling from the shorter end faces of the tube 3, where it is not needed. As a result of the blowing, the end faces become clean and an amount of soldering material is saved corresponding to about 12% of the amount that would be needed if no blowing were applied.

Further, the apparatus comprises a pressing device 7 placed after the blowing device 17 as seen in the direction of motion of the tube. The pressing device consists of two rollers placed one above the other, the liquid flow tube 3 being passed between them. The rollers press the tube 3 from the ends of the cross-section with a suitable force so that the side faces 14 of the tube buckle back into their original position, the convex profile of the tube being thus restored. The soldering material layer 15 on the side faces buckles outwards at the same time, increasing the total convexity of the cross-section. At this stage, the tube 3 has reached the desired shape. A corresponding cross-section is shown in FIG. 6.

According to the general principle of the method of the invention, a liquid flow tube, as well as other metal surfaces, is coated as follows: The metal surface 3 to be coated is first conveyed into the space 5 serving as a coating material container, which contains material 6 intended for the coating of metal surfaces. The aforesaid coating material 6 is caused to adhere in space 5 to the metal surface 3, whereupon the metal surface is passed out from the space 5 in such manner that the material layer 15 intended to form a coating is adjusted to a predesired position and thickness.

When liquid flow tubes 3 are to be coated with soldering material paste, the leading end of the tube coming out of the tube manufacturing machine is first passed to the compressing device 4 and then further into the coating material container 5 through the feed opening 12 in the front wall of the container. At this stage, the coating material container is empty or the surface of the soldering material paste 6 has been lowered to a level below the feed opening and output opening 13. Next, the leading end of the tube 3 is directed further into the output opening 13 and through it so that it extends outside the coating material container 5. The openings of the coating material container are now sufficiently tight and the container can be filled with soldering material paste up to a desired upper limit. After that, the actual coating operation can be started, whereupon the process continues as described in the example represented by FIGS. 1 and 2. The compressing device 4 causes the elongated side faces 14 of the tube to collapse inwards and pushes the tube 3 first through the coating material container 5, where soldering material paste 6 intended to form a coating is caused to adhere to the surface of the tube. A soldering material layer 15 of desired thickness and shape is formed on the elongated side faces 14 of the tube by passing the tube through the output opening 13, the soldering material layer 15 being thereby adjusted to the desired form. After this, the tube 3 is first passed to the blowing device 17, which blows off the soldering material paste from the short end faces of the tube. After that, the tube 3 is passed further to the pressing device 7, where the elongated side faces 14 of the tube are caused to buckle outwards substantially into their original form, and finally the tube is passed into the cooling unit 8, where the soldering material layer 15 is solidified by quickly cooling it by means of carbon dioxide e.g. from a temperature of +85 . . . +95° C. to a temperature of about +45 . . . +50° C. The tube is then cut to appropriate lengths and stored for future use.

FIG. 7 presents a more detailed illustration of how the soldering material paste is blown off from the short end faces of the tube 3. As the tube emerges from the coating material container 5, it has paste 15 overall on its outer surface, although the layer of paste on the short end faces of the tube is thinner because the output opening 13 has already doctored off some of it. A high pressure is now applied to the short end faces of the tube by blasting them with air through the thin nozzles 16 of the blowing device 17. As a result, the soldering material paste 15 escapes due to the air flow as shown in the figure to the side walls of the tube 3 or into a collecting container provided below the tube. The result is a tube end face free of soldering material paste.

It is obvious to the person skilled in the art that the invention is not limited to the example described above, but that it may be varied within the scope of the claims presented below. Thus, the solution of the invention is not limited to coating flow tubes 3 with soldering material paste as described above; instead, the invention can be applied in all types of coating work in which a sufficiently heat-resistant material is to be coated with a material containing metal, making it possible to produce e.g. corrosion-resistant surfaces, impact-resistant surfaces, artistic decorative surfaces, etc.

Similarly, the invention is not limited to the use of liquid soldering material paste or corresponding coating material.

The coating material container 5 or equivalent may just as well contain coating material 6 in powdery form and the coating can be carried out using an electric charge as in the powder painting process. The binding material used may consist of any of the following materials: water-thinnable binder, solvent-thinnable thermoplastic or reticulating polymer, such as acryl, polyethylene, epoxy, polyester, copolymer or other equivalent binding agent; wax or hot wax; powdery materials.

In respect of solidification of the coating material, too, the invention is not limited to the above-described procedure; instead, besides via cooling by the use of carbon dioxide or equivalent, solidification may be accomplished either by heating or e.g. by using short-wave light, such as UV light, infrared light, or by using combinations of some of the aforesaid alternatives.

In addition, the material composition of the soldering material is not accurately defined in the invention. For example, the amount of binding agent in the soldering material may vary between 1 . . . 30%, calculated as dry matter of the solder metal. Likewise, the melting temperature of the metallic component (Cu, Zn, Ni, P) of the soldering material may vary within the range or 200 . . . 1000° C.

Moreover, the feed and output openings for different tube sizes or profiles or for altogether other profiles may be incorporated in separate elements. By changing such elements, suitable openings for each tube size and profile or other profile are easily provided. Likewise, the shape and size of the openings may be adjustable.

1. Method for coating a metal surface, such as the surface of the liquid flow tubes (3) used in cooling radiators and heat exchangers, with a thin layer of material containing metal, in which method the metal surface of the liquid flow tube (3) to be coated is caused to move into a container like space (5) containing material (6) intended for the coating of metal surfaces, which material (6) intended for coating is caused to adhere in the container-like space 95) to the metal surface of the liquid flow tube (3), whereupon the metal surface of the liquid flow tube (3) is passed out of the container-like space (5) and the material layer (15) intended to form a coating is adjusted to a predesired position and thickness, characterized in that the material layer (15) intended to form a coating is adjusted to a predesired position and thickness in connection with its emergence from the container-like space (5) by removing at least some of the undesirable coating material (15) from the surface and end faces of the liquid flow tube (3).

2. Method according to claim 1 for coating the surface of liquid flow tubes (3), characterized in that the elongated side faces (14) are caused to collapse towards each other, whereupon the liquid flow tube (3) is passed into the container-like space (5), where material (15) intended for coating is adhered to the metal surface, and that, after the adherence, the original cross-sectional profile of the liquid flow tube (3) is restored by causing the elongated side faces (14) of the liquid flow tube (3) to buckle outwards from each other.

3. Method according to claim 1 or 2 for coating the surface of liquid flow tubes (3), characterized in that, after the liquid flow tube (3) has emerged from the container-like space (5), undesirable coating material (15) is removed from end faces of the liquid flow tube (3) by blowing pressurized air to the surface of the end faces.

4. Method according to claim 1 for coating the surface of liquid flow tubes (3), characterized in that the liquid flow tube (3) is kept moving in the direction of the tube with respect to the container-like space (5) at least during the coating operation.

5. Method according to claim 1, characterized in that the coating material (6) consists of liquid soldering material paste.

6. Method according to claim 1, characterized in that the coating material (6) consists of powdery soldering material which is fixed to the metal surface (3) to be coated by using an electric charge.

7. Apparatus for coating a metal surface (3) with a thin layer of material containing metal, said apparatus comprising a container-like space (5) containing coating material (6) and provided with a feed opening (12) and an output opening (13) for the metal surface (3) to be coated, at least one of which openings is disposed below the upper surface of the coating material (6), characterized in that the metal surface to be coated is a flat liquid flow tube (3) and that, placed before the container-like space (5) in the direction of motion of the tube, the apparatus has a compressing device (4) for collapsing the elongated side faces (14) of the liquid flow tube (3) towards each other, and that, placed behind the container-like space (5) in substantially the same direction of motion, the apparatus has a pressing device (7) for buckling the elongated side faces (14) of the liquid flow tube (3) outwards from each other to restore substantially the original cross-sectional form.

8. Apparatus according to claim 7, characterized in that the compressing device (4) is a double roller assembly consisting of pressing rollers (10) so arranged that they press the elongated side faces (14) of the liquid flow tube (3) towards each other, and that the pressing device (7) is a unit consisting of at least two rollers fitted to press the liquid flow tube (3) from its narrow edges so as to cause the elongated side faces (14) of the liquid flow tube (3) to buckle substantially back to their original form.

9. Apparatus according to claim 7 or 8, characterized in that the minimum height of the output opening (13) is substantially equal to the maximum height of the cross-sectional profile of the liquid flow tube (13) to be coated, and that the minimum width of the output opening (13) is substantially equal to the maximum width of the liquid flow tube (3) to be coated as measured before the pressing device (7), and that the feed opening (12) and the output opening (13) are splayed in the direction of motion of the liquid flow tube (3) so that the area of each opening is larger on the side from where the tube enters the opening than on the side where the tube leaves it.

10. Apparatus according to claim 1 equipment claims, characterized in that, placed after the output opening (13) in the direction of motion of the tube, the apparatus has a blowing device (17) provided with at least one nozzle (16), which is directed towards the short end face of the tube (3) and designed to pass an air flow through it to clean off any coating material (6) from the short end faces of the tube (3).
